(19) United States
(12) Patent Application Publication
(10) Pub. No.: US 2019/0392041 A1
(43) Pub. Date: Dec. 26, 2019

(54) IMPLEMENTING INTELLIGENT STANDARD DEVIATION INSERTS INTO A RELATIONAL DATABASE MANAGEMENT SYSTEM

(71) Applicant: International Business Machines Corporation, Armonk, NY (US)

(72) Inventors: John M. Santosuosso, Rochester, MN (US); Jim C. Chen, Rochester, MN (US); James E. Carey, Rochester, MN (US)

(21) Appl. No.: 16/032,385

(22) Filed: Jul. 11, 2018

Related U.S. Application Data
(60) Provisional application No. 62/690,130, filed on Jun. 26, 2018.

(51) Int. Cl. G06F 17/30; G06F 17/18

(52) U.S. Cl. CPC G06F 17/3051; G06F 17/18; G06F 17/30407; G06F 17/30595

(57) ABSTRACT

A method, system and computer program product are provided for implementing intelligent standard deviation inserts into a relational database management system (RDBMS). A trigger program type logic is provided within a database for processing outlier data based upon deviation constraints. The processed outlier data is used for automatically taking appropriate action including preventing insertion of outliers into the Relational Database Management System (RDBMS).

### FIELD OF THE INVENTION

The present invention relates generally to the data processing field, and more particularly, relates to a method, system and computer program product for implementing intelligent standard deviation inserts into a relational database management system (RDBMS).

### DESCRIPTION OF THE RELATED ART

In the world of Internet of Things (IoT) and Big Data in general an emphasis is often placed on finding and doing something about outlying information. Outlying information currently is not simply a static relationship of values but an evolving relationship such that one can think of deviations within a given window of time.

A novel database system is needed to effectively address outlying information to provide enhanced and improved database operation.

A need exists for an efficient and effective mechanism for implementing intelligent standard deviation inserts into a relational database management system (RDBMS).

### SUMMARY OF THE INVENTION

Principal aspects of the present invention are to provide a method, system and computer program product for implementing intelligent standard deviation inserts into a relational database management system (RDBMS). Other important aspects of the present invention are to provide such method, system and computer program product substantially without negative effects and that overcome many of the disadvantages of prior art arrangements.

In brief, a method, system and computer program product are provided for implementing intelligent standard deviation inserts into a relational database management system (RDBMS). A trigger program type logic is provided within a database for processing outlier data based upon deviation constraints. The processed outlier data is used for automatically taking appropriate action including preventing insertion of outliers into a Relational Database Management System (RDBMS).

In accordance with features of the invention, processing outlier data based upon deviation constraints ensures that the outlier data is reasonable before insertion into the database.

In accordance with features of the invention, processing outlier data based upon deviation constraints includes when inserting data checking whether data values of a given column or columns are within 1, 2 or X amount of deviations.

In accordance with features of the invention, deviation checks are configurable by a database administrator.

In accordance with features of the invention, processing outlier data based upon deviation constraints ensures that the outlier data records being inserted have reasonable values, given a sliding time window.

In accordance with features of the invention, when the data value being inserted has a higher value than a specified deviation constraint, then an appropriate action to reject the insert, provide warning messages on the insert or take another form of corrective action.

In accordance with features of the invention, when the data value being inserted has a higher value than a specified deviation constraint, then the insert optionally is stored in a holding data structure, and not return the insert with normal queries.

In accordance with features of the invention, an insert optionally stored in a holding data structure are returned with normal queries when a specified number of deviant values occur within a specified time frame.

In accordance with features of the invention, processing outlier data based upon deviation constraints includes providing deviation constraints and deviation values within a given window of time.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 provides a block diagram of an example computer system for implementing intelligent standard deviation inserts into a relational database management system (RDBMS) in accordance with preferred embodiments;

FIGS. 2 and 3 are respective flow chart illustrating example system operations to implement intelligent standard deviation inserts into a relational database management system (RDBMS) of FIG. 1 in accordance with preferred embodiments; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and system are provided for implementing intelligent standard deviation inserts into a relational database management system (RDBMS).

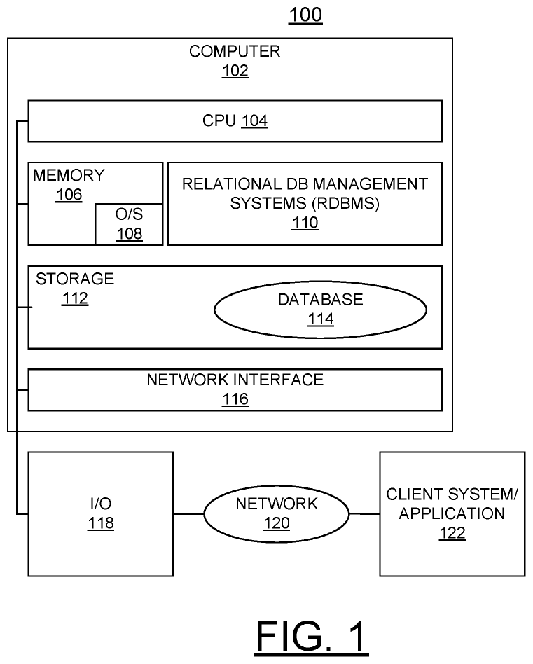

Having reference now to the drawings, in FIG. 1, there is shown an example system embodying the present invention generally designated by the reference character 100 for implementing intelligent standard deviation inserts into a relational database management system (RDBMS) in accordance with preferred embodiments. System 100 includes a computer system 102 including one or more processors 104 or general-purpose programmable central processing units (CPUs) 104. As shown, computer system 102 includes a single CPU 104; however, system 102 can include multiple processors 104 typical of a relatively large system.

Computer system 102 includes a system memory 106 including an operating system 108 and relational database management systems (RDBMS) 110. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

Computer system 102 includes a storage 112 including a database 114 and a network interface 116. Computer system 102 includes an I/0 interface 118 for transferring data to and from computer system components including CPU 104, memory 106 including the operating system 108 and RDBMS 110, storage 112 including database 114, and network interface 116 and a network 120 and a client system and application 122.

In accordance with features of the invention, the new computer system 102 of the preferred embodiment implements special processing of outlying data to ensure data to be inserted into the database 114 is reasonable, effectively addressing outlying information to provide enhanced and improved database operation.

In accordance with features of the invention, when the value being inserted has a higher value from a deviation perspective then an appropriate action is taken including a selected one of: reject the insert, provide warning messages on the insert and take some other form of corrective action. For example, the database can hold the outlier values in a separate data structure, possibly holding table, and not return the outlier values to normal queries. The outlier values in a separate data structure optionally are returned to normal queries when a specified number of deviant values occur within a specified time frame. For example, once an hour is probably a glitch, but two a minute is a problem, the outlier values optionally are included in the data or a corrective action is taken. How to handle held results is configured, for example by the application programmer and the database administrator.

In accordance with features of the invention, partitioning data into a held structure has uses that go beyond just holding data for deviant values. When inserting blocks of records it can be ensured that all records are within a specified deviation value. This means that a group of records can be inserted within a single statement or an insert could be done via sub-select query. This gives a natural grouping of records to act upon. The deviation can be made to be computed by looking at records inserted within a given time frame such as a last 5 minutes, last 30 minutes, the last day, and the like. Also a specified X amount of previously inserted records can make up a window of records that are used to decide what the deviation values to be computed with. Furthermore the deviation can be broken into where the data is being inserted from and or who is doing the inserting.

In accordance with features of the invention, for example a drone may report its position as part of its information packet. Its position, while changing, cannot change more than a certain amount during a given time frame. Thus an information packet that contains a position value that deviates dramatically from the previous window of positions is suspect and should either be ignored or analyzed more carefully. An interesting aspect of this example, is that the deviation can also be dependent on a time aspect of the data, for example, where either the arrival time of the information packet, such as row insertion time or a timestamp provided in the information packet, data within the row.

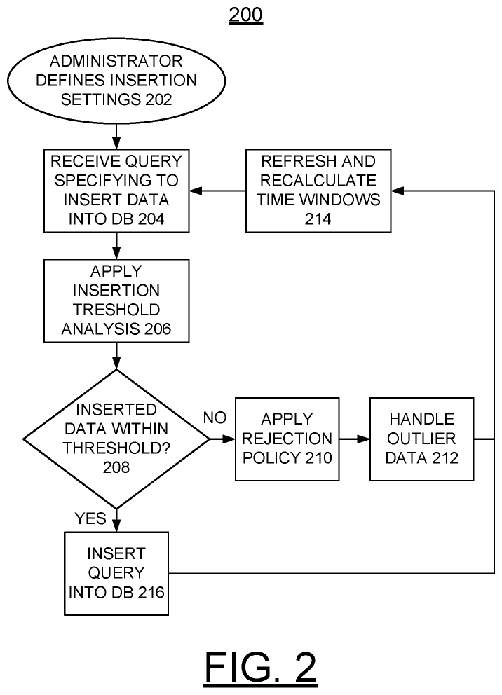

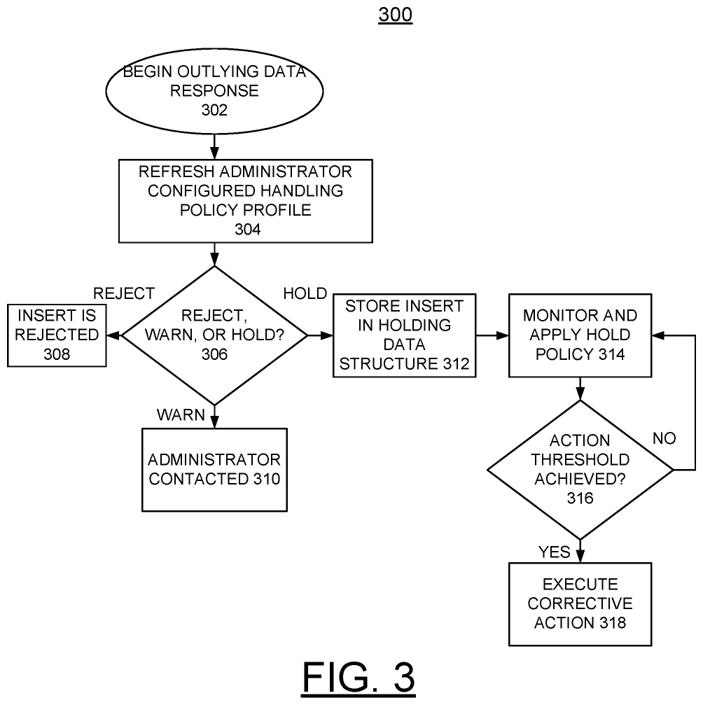

Referring to FIGS. 2 and 3, there are shown example system operations generally designated by the reference characters 200 and 300 of computer system 102 of FIG. 1, for implementing intelligent standard deviation inserts into a relational database management system (RDBMS) in accordance with preferred embodiments.

Referring to FIG. 2, operations start at a block 202 with an administrator defining insertion settings. As indicated at a block 204, a query specifying to insert data into a database (DB) is received. As indicated in a block 206, insertion threshold analysis is applied to the received query. As indicated in a decision block 208, checking whether the insert data is within a predefined threshold is performed. As indicated in a block 210, a rejection policy in accordance with preferred embodiments is applied when insert data is not within the predefined threshold. The outlier data is handled in accordance with preferred embodiments as indicated in a block 212, for example as illustrated and described in FIG. 3. Time windows are refreshed and recalculated in accordance with preferred embodiments as indicated in a block 214 and operations continue with receiving a next query at block 204. When insert data is identified within the predefined threshold at decision block 208, then the query specifying to insert data is inserted into the database (DB) as indicated in a block 216

Referring now to FIG. 3, there are shown example system operations of computer system 102 of FIG. 1, for implementing intelligent standard deviation inserts into a relational database management system (RDBMS) in accordance with preferred embodiments starting at a block 302 where outlying data response begins. As indicated at a block 304, an administrator configured handling policy profile is refreshed. As indicated at a decision block 306, determining whether to reject, warn, or hold an outlier data insert is performed. For a reject determination, the outlier data insert is rejected as indicated at a block 308. For a warn determination, an administrator is contacted as indicated at a block 310. For a hold determination, outlier data insert is inserted into a holding data structure, for example within the database as indicated at a block 312. Then the hold policy is monitored and applied as indicated at a block 314. Checking whether an action threshold is achieved is performed as indicated at a decision block 316. When the action threshold is not achieved, operation continue at block 314 to monitor and apply the hold policy. When the action threshold is achieved, at least one corrective action is executed as indicated at a block 318.

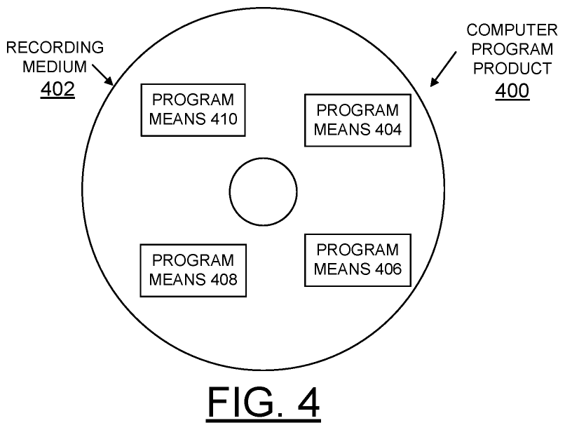

Referring now to FIG. 4, an article of manufacture or a computer program product 400 of the invention is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. The computer readable storage medium 402, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 402 stores program means or instructions 404, 406, 408, and 410 on the non-transitory computer readable storage medium 402 for carrying out the methods for implementing intelligent standard deviation inserts into a relational database management system (RDBMS) in the system 100 of FIG. 1.

Computer readable program instructions 404, 406, 408, and 410 described herein can be downloaded to respective computing/processing devices from a computer readable storage medium or to an external computer or external storage device via a network, for example, the Internet, a local area network, a wide area network and/or a wireless network. The computer program product 400 may include cloud based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 404, 406, 408, and 410 from the network and forwards the computer readable program instructions for storage in a computer readable storage medium within the respective computing/processing device.

A sequence of program instructions or a logical assembly of one or more interrelated modules defined by the recorded program means 404, 406, 408, and 410, direct the system 100 for implementing intelligent standard deviation inserts into a relational database management system (RDBMS) of the preferred embodiment.

While the present invention has been described with reference to the details of the embodiments of the invention shown in the drawing, these details are not intended to limit the scope of the invention as claimed in the appended claims.

What is claimed is:

1. A system for implementing intelligent standard deviation inserts into a relational database management system (RDBMS) comprising:
a trigger program control logic,
said trigger program control logic tangibly embodied in a non-transitory machine readable medium used to implement intelligent standard deviation insertion;
said trigger program control logic, processing outlier data based upon deviation constraints; and
said trigger program control logic, using the processed outlier data for automatically taking an appropriate action including preventing insertion of outliers into a Relational Database Management System (RDBMS).

2. The system as recited in claim 1 wherein said trigger program control logic, processing outlier data based upon deviation constraints includes defining insertion values used by said trigger program control logic.

3. The system as recited in claim 1 wherein said trigger program control logic, processing outlier data based upon deviation constraints includes ensuring outlier data records being inserted have reasonable values within a sliding time window.

4. The system as recited in claim 3 includes rejecting an insert.

5. The system as recited in claim 3 includes providing error codes and warning messages on an insert.

6. The system as recited in claim 3 includes storing an insert in a holding data structure.

7. The system as recited in claim 1 wherein said trigger program control logic, processing outlier data based upon deviation constraints includes identifying specified deviation values within a given time frame.

8. The system as recited in claim 1 includes control code stored on a non-transitory computer readable medium, and wherein said control code is used for implementing intelligent standard deviation inserts.

9. A method for implementing intelligent standard deviation inserts into a relational database management system (RDBMS) comprising:
providing a trigger program control logic, said trigger program control logic tangibly embodied in a non-transitory machine readable medium used to implement intelligent standard deviation insertion; said trigger program control logic:
processing outlier data based upon deviation constraints; and
using the processed outlier data for automatically taking an appropriate action including preventing insertion of outliers into a Relational Database Management System (RDBMS).

10. The method as recited in claim 9 wherein processing outlier data based upon deviation constraints includes applying insertion threshold analysis.

11. The method as recited in claim 9 wherein processing outlier data based upon deviation constraints includes identifying deviant data values within a specified time period.

12. The method as recited in claim 9 wherein processing outlier data based upon deviation constraints includes checking whether data values of one or more given database columns are within specified amount of deviation.

13. The method as recited in claim 9 wherein processing outlier data based upon deviation constraints includes using configurable deviation checks.

14. The method as recited in claim 9 wherein processing outlier data based upon deviation constraints includes identifying a data value being inserted having a higher value than a specified threshold deviation constraint.

15. The method as recited in claim 14 includes storing a data insert in a holding data structure.

16. The method as recited in claim 9 wherein processing outlier data based upon deviation constraints includes identifying deviation values within a specified window of time.

17. The method as recited in claim 9 wherein processing outlier data based upon deviation constraints includes identifying deviation values outside a threshold value, and applying a stored rejection policy.

18. The method as recited in claim 17 includes one of rejecting an insert and providing error codes and warning messages on an insert.

19. The method as recited in claim 17 includes automatically taking an appropriate action including holding outlier values in a separate data structure.

20. The method as recited in claim 17 ensuring data to be inserted is reasonable, effectively addressing outlying information to provide enhanced and improved database operation.
